(19) United States
(12) Patent Application Publication
(10) Pub. No.: US 2022/0395073 A1
(43) Pub. Date: Dec. 15, 2022

(54) A dosing device to dispense two or more different scented fragrances mixed together

(71) Applicants: Martina Corezzi, Firenze (IT); Lapo Quagli, Firenze (IT)

(72) Inventors: Martina Corezzi, Firenze (IT); Lapo Quagli, Firenze (IT)

(21) Appl. No.: 17/776,597

(22) PCT Filed: Nov. 20, 2020
(86) PCT No.: PCT/IB2020/060954

§ 371 Date: May 13, 2022

(30) Foreign Application Priority Data
Nov. 20, 2019 (IT) 102019000021681

(51) Int. Cl. A45D 34/02; A45D 34/04; B01F 25/312; B01F 33/84; B05B 12/14; B05B 7/24

(52) U.S. Cl. CPC A45D 34/02; A45D 34/04; B01F 25/31242; B01F 33/84; B05B 12/1418; B05B 7/2427; A45D 2200/057; A45D 2200/058; B01F 2101/21

(57) ABSTRACT

A fragrance dispensing system includes a first and a second container each having a main tube for the expulsion of a fragrance contained therein, and a dispensing device that provides a dispensing path towards an outlet section and that includes a mixing chamber and a first and second auxiliary tubes connected at one end to the mixing chamber. A containing case forms a seat containing the first and second containers, and a cap is configured to be applied on the containing case and houses the mixing chamber, an outlet section for the mixed fragrances and, at least partly, and the first and second auxiliary tubes, each of which has a free end separably connected to one of the main tubes when the cap is engaged to the case.

### SCOPE OF THE INVENTION

The present invention relates to the technical sector relating to fragrance containers.

In particular, the invention refers to an innovative dispenser capable of dispensing two or more different fragrances by mixing them appropriately with each other, thus also allowing the fragrances to be varied.

### OVERVIEW OF THE PRIOR ART

Perfume dispensers and perfumes have obviously been known for hundreds of years.

The creation of a perfume is very complex as it requires the selection of perfumed substances, generally flowers, plants, etc., and their treatment in order to obtain a perfumed liquid which is then bottled in precious bottles. Generally these bottles, or generic containers, are equipped with a spray dispenser which allows the perfume to be sprayed through a nozzle from which the liquid contained in the bottle comes out vaporized and, in particular, in the form of micro drops.

Through the dispenser it is possible to spray a predetermined dose of perfume which is vaporized through the dispenser and therefore projected at a certain distance from the dispenser in the form of micro drops, i.e. in vaporized form.

The technology linked to spray vaporization has been known since the early twentieth century and widely used in many sectors, not only that of perfumes, and therefore is not further detailed here.

In the current state of the art, perfume vials/bottles are commercially known provided with a single dispenser such that only the perfume contained in the bottle can be sprayed.

Basically, the bottle has on its top the spray nozzle, which communicates with the liquid through a duct that dips into the liquid inside the bottle. Acting by pressing on the dispenser, pressure is generated on the duct which moves downwards, thus activating the dispensing; in this way the liquid contained in the bottle comes out through the dispenser in the form of micro drops.

Therefore, anyone wishing to modify the fragrance according to their desires cannot do so with the current dispensers which, as stated, dispense a single fragrance.

To make variations at will, the user should try to spray several different scents from different bottles.

In this regard, fragrance dispensers exist that contain several perfume bottles and allow the selective dispensing of each one of them through a number of dispensing outlets corresponding, obviously, to the number of bottles.

According to this solution, no mixing of perfumes takes place inside the device itself and each perfume follows its own delivery path independently from the others.

The user can therefore choose to dispense several perfumes at the same time.

In this case, therefore, the mixing is not optimal because the mix of perfumes actually results in a simple overlapping on the outside (this technique is already known in the perfumery sector and called “layering”) of two or more perfumes sprayed directly onto the subject's body.

Publication WO2014/154909 is known, which describes a system which mixes several fragrances inside the device and therefore before dispensing. The perfume dispensed therefore results in a single perfume which is the result of a mixture of several perfumes and not in a “layering” of several perfumes. This solution is used in the cinematographic field and is particularly complex as it is structured in such a way as to deliver a fragrance directly into the nasal cavity according to a predetermined scene that the user is following.

The system described provides for a compressor which delivers a propelling gas which, through suitable ducts, is sent to individual fragrance cartridges. The gas pushes the fragrance contained in the cartridges towards an outlet. A flow regulator allows the flow of gas to one or more of the cartridges to be regulated, with everything being controlled by a PC based on the video being played. The gas thus pushes the fragrance contained in the cartridges towards a mixing chamber and from there towards an outlet. In this way, individual fragrances or a combination of these can be sent directly into the user's nasal cavity, who therefore smells scents in correlation with the video he is watching.

This solution, while allowing fragrances to be mixed inside the device, is structurally complex as it is controlled by a PC and is designed to be installed, for example, in the seats of a cinema or theater in order to generate a fragrance compatible with the scenes that the user is seeing.

It is therefore not suitable for day-to-day personal use.

### SUMMARY OF THE INVENTION

The object of the present invention is therefore to provide a dispenser for perfumes which, at least partially, solves the above-mentioned technical drawbacks.

In particular, the object of the present invention is to provide a dispensing device structured to allow the mixing together of two or more perfumes, so that the user can act through this dispenser in a simple and functional way in order to be able to dispense a single flow of perfume that is the result of a mix of different fragrances.

More specifically, the object of the present invention is to provide a dispensing device that is structurally simple, allowing the user to use it on a daily basis exactly as with common fragrance bottles, obtaining a predefined mixture.

These and other objects are therefore achieved with the present dispensing device for the dispensing of a fragrance coming from at least one first and at least one second container of fragrance, the dispensing device including:
A dispensing path (5a, 6a, 10, 25) configured to guide, in use, the fragrance contained in said first and second containers towards an outlet section (25);
Said dispensing path comprising a mixing chamber (10) arranged so as to receive, in use, said at least one first and second fragrance coming from said first and second containers (3, 4) thus causing them to be mixed therein before being expelled to the outside of the dispensing device.
Said delivery path further comprises a first and a second auxiliary tube (5a, 6a), said auxiliary tubes being connected at one end to the mixing chamber (10);

According to the invention, the dispensing device further comprises a containing case (2) forming at least one seat for containing said at least one first and at least one second container.

In this way, interchangeably, it is possible to arrange these two or more perfumes containers in the case, in a suitable seat.

The fragrance containers can be of the disposable type or of the refillable and/or recyclable type.

The user can therefore purchase two or more fragrance containers and load them into the case.

According to the invention, a cap (11) is further provided configured to be applied on top of said case (2).

The cap (11) comprises said mixing chamber (10), for example in that it is made in one piece in the cap or is housed in a suitable seat made in the cap; the cap further comprises an outlet section (25) for the mixed perfume. Moreover, said cap further forms at least one passage in which are housed, for at least part of their length, said first and second auxiliary tubes (5a, 6a) which are connected to said mixing chamber.

The said first and second tubes (5a, 6a) each have a free end at the end opposite that of connection with the mixing chamber, said free ends being, each one, configured to separably connect to one of said fragrance containers in correspondence with the application of said cap on the case when the containers are placed in said case.

In this way, once the fragrance containers have been inserted into the case and the cap has been applied, the auxiliary paths are automatically connected to the containers, thereby generating the outlet path for the liquid fragrance from the container towards the outside.

On removing the cap, the auxiliary tubes are separated from the containers.

Said cap is furthermore provided with a dispensing actuation system.

In this way, two or more of said containers can be loaded into the case and the cap applied. The operation of applying the cap leads to the auxiliary tubes being connected with the inserted containers, thus generating a path that, at the time of dispensing, brings the individual fragrances into the mixing chamber and from there towards the outlet.

In this way a portable device is obtained, for daily use, which allows the dispensing of a single flow of fragrance which is however the result of a mixing of several perfumes together.

Similarly to what has been outlined above, a fragrance dispensing system is also described here comprising:
At least one first container (3) and at least one second container (4), each one suitable for containing a fragrance, said first and second containers each comprising a main tube (5, 6) for expulsion of the fragrance.

As said, such containers can, for example, be of the disposable type or of the refillable and/or recyclable type.
The system further comprises a dispensing device (1) suitable for dispensing said fragrance contained in said first and second containers, said dispensing device in turn comprising:
A dispensing path (5a, 6a, 10, 25) configured to be able to guide the fragrance contained in said first and second containers towards an outlet section (25);
Said dispensing path comprising a mixing chamber (10) arranged so as to receive, in use, said at least one first and second fragrance coming from said first and second containers (3, 4) thus causing them to be mixed therein before being expelled to the outside of the dispensing device.
Said dispensing path further comprises a first and a second auxiliary tube (5a, 6a), the auxiliary tubes being connected at one end to the mixing chamber (10) in such a way that the liquids coming from said two separate containers (3, 4) move along the respective main tubes and are conveyed into the mixing chamber, where they are mixed, through said auxiliary tubes (5a, 6a).

According to the invention, said dispensing device further comprises a containing case (2) forming at least one seat for containing said at least one first and at least one second container and a cap (11) configured to be applied on top of said case (2).

The cap (11) comprises said mixing chamber (10) and a mixed perfume outlet section (25).

Moreover, said cap further forms at least one passage in which are housed, for at least part of their length, said first and second auxiliary tubes (5a, 6a) which are connected to said mixing chamber.

These first and second tubes (5a, 6a) each have a free end at the end opposite that of connection to the mixing chamber, said free ends being disconnected from the main tubes.

These free ends are, each one, configured to separably connect to one of said main tubes in correspondence with the application of said cap on the case, so as to generate the exit path for the liquid fragrance from the container towards the outside and separate from said main tubes in correspondence with the separation of the cap from the case.

Said cap being further provided with a dispensing actuation system.

In this way, as stated previously, a portable device is obtained for day-to-day use, allowing several perfumes to be mixed together.

Advantageously, for all the configurations described above, said dispensing actuation system can comprise a lever system (7) applied to said cap which causes a movement of said auxiliary tubes which generate a crushing pressure on the main tubes to which they are connected.

The auxiliary tubes are therefore flexible and connected to the lever system so as to move following the actuation of the lever system, so that they act on the main tubes belonging to the fragrance containers, thereby causing dispensing.

Advantageously, for all the configurations described above, said lever system can comprise:
A central lever (7);
Two lateral levers (8, 9);
A rigid transversal rod (20) which connects the central lever to the two lateral levers in such a way that, by acting on said central lever with a pressure in the direction of the cap, a simultaneous movement of the lateral levers is obtained.

Advantageously, for all the configurations described above, the two lateral levers (8, 9) are connected, one of them to the first auxiliary tube (5a) and the other lateral lever being connected to the other auxiliary tube (6a) in such a way that a movement of said lateral levers with an approaching motion in the direction of the cap causes a movement of said auxiliary tubes which generate a crushing pressure on the main tubes to which they are connected.

Alternatively, advantageously and for all the configurations described above, said dispensing actuation system may comprise a system of pressure buttons applied to said cap which causes a movement of said auxiliary tubes which always generate a crushing pressure on the main tubes to which they are connected.

According to this solution, advantageously and for all the configurations described above, at least two buttons can be provided on the cap, one of them connected to the first auxiliary tube (5a) and the other button being connected to the other auxiliary tube (6a) in such a way that pressure on said buttons with an approaching motion in the direction of the cap causes a movement of said auxiliary tubes which generate a crushing pressure on the main tubes to which they are connected.

Advantageously, therefore, for all the configurations described above, said auxiliary tubes are made of flexible material so as to respond with a deformation following said actuation of the lateral levers or of the buttons connected to them, thereby determining said crushing pressure on the main tubes.

Advantageously, for all the configurations described above, thrust means are included configured to move said at least one first and second fragrance towards the outlet from said first and second containers along said main tubes belonging to said containers and which penetrate inside said containers for drawing up the liquid fragrance.

In a preferred embodiment, said thrust means are integrated inside said first and second containers.

In this case, for example, said thrust means can comprise a thrust fluid, preferably a gas (for example an inert gas), contained directly in said first and second containers and which is activated, causing the outflow of the fragrance, following said pressing acting on the relative main tube and therefore the relative lowering of the tube (fitted translatably as in the known art).

Alternatively, advantageously and for all the configurations described above, said thrust means can comprise a piston arranged inside each fragrance container and arranged translatably inside the container, the piston being connected to the relative main tube of the container in which it is arranged (obviously also translatable) in such a way that, following pressing of the tube, the latter is lowered causing a translation of the piston which moves towards the bottom of the container generating an increase in internal pressure in function of the thrust and the lowering acting on the relative main tube.

Advantageously, for all the configurations described above, said thrust means can be separate from said first and second containers and therefore result in independent and external components.

For example, advantageously and for all the configurations described above, according to this alternative, said thrust means can comprise a third container (30) of pressurized fluid, preferably an inert gas (30), which is injected into said at least one first and second containers through appropriate tubes (22, 23) to cause outflow of the liquid fragrance.

In this case, advantageously, said containing case provides a further seat for containing said third container of pressurized fluid.

In this case, advantageously and for all the configurations described above, a further tube is provided which connects the fluid container (30) with the tailpiece of the mixing chamber (10) so that the fluid injected into the tailpiece of the mixing chamber generates a thrust that facilitates the expulsion of the fragrance mix out of the dispensing device.

In accordance with this solution, advantageously and for all the configurations described above, said cap further forms at least one passage in which are housed, for at least part of their length, the first and second auxiliary tubes (5a, 6a) which are connected to said mixing chamber and the tube connecting the third container (30) with the tailpiece of the mixing chamber.

In this way, just as for the other configurations, application of the cap on the case leads to the main tubes of the containers being connected with the auxiliary ones to generate the dispensing path.

In this case, actuation of the dispensing acts on the propulsion gas container.

In particular, advantageously and for all the configurations described above, said tubes (22, 23) converging at the container (30) are controlled in opening and closing by means of flow control valves (23V, 22V, 21V), preferably solenoid valves.

Advantageously and for all the configurations described above, the opening and closing of the flow adjustment valves (23V, 22V, 21V) is commanded by way of a control button on the cap.

The propulsion gas canister is pressurized so that when a valve is opened, the gas flows out automatically.

Advantageously and for all the configurations described above, said valves can therefore assume an open/closed position and/or intermediate positions.

Advantageously and for all the configurations described above, said containing case may for example be cylindrical or substantially cylindrical.

Advantageously and for all the configurations described above, said seat of the containing case (2) can be opened at the top to allow the insertion, in a removable way, of said at least one first and second containers.

Advantageously and for all the configurations described above, said cap can be removed from the case.

Advantageously and for all the configurations described above, the mixing chamber has a Venturi-tube conformation.

This Venturi tube has the advantage of allowing a more precise mixing of the perfumes and moreover, where propulsion gas is used, effectiveness of the mixing is further optimized. This results in a better quality fragrance mix. Tests have demonstrated this effect.

### BRIEF DESCRIPTION OF THE DRAWINGS

Further characteristics and advantages of the present fragrance dispenser, according to the invention, will be clarified with the description that follows of some of its embodiments, provided by way of non-limiting example, with reference to the attached drawings, where:

FIGS. 1 to 3 show a first configuration of the invention illustrating a containing case in which are housed two bottles of different fragrance which are mixed and dispensed together through the dispensing system; The section of FIG. 3 shows in section the cap of the case in which the mixing chamber is obtained and with this section rotated through ninety degrees with respect to the cap from which it is obtained, FIG. 2 shows in particular a lever system for dispensing applicable to all the configurations described of the invention;

FIG. 3A shows an alternative dispensing system to the lever system in the form of buttons and always applicable to all configurations of the invention; FIG. 3B is an exploded view of the device according to the embodiment of FIG. 3A;

FIGS. 4 and 5 show a second configuration of the invention.

### DESCRIPTION OF SOME OF THE PREFERRED EMBODIMENTS

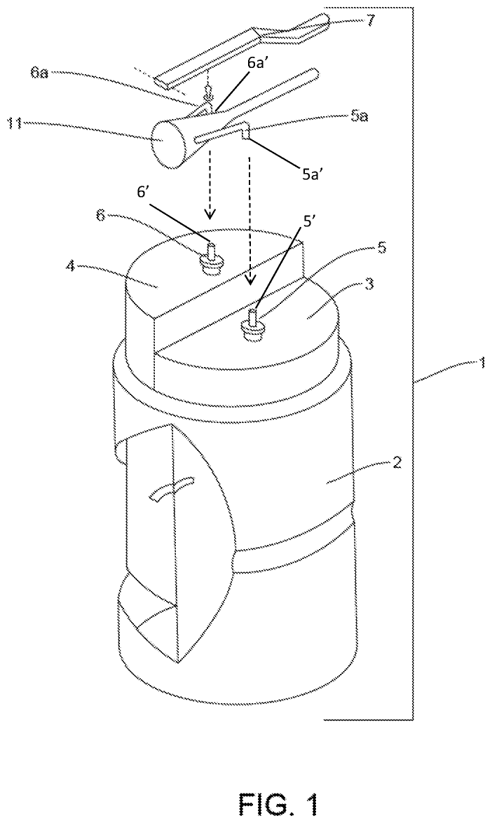

FIG. 1 describes an assembly 1 according to a first possible preferred configuration of the invention, which on the whole forms a fragrance dispenser, preferably perfumes for personal use on the body.

A containing case 2 is therefore provided which can for example have a cylindrical shape and be opened from the top part so as to be able to insert and contain therein two distinct fragrance bottles (3, 4).

The case will therefore have a cylindrical side wall of predetermined height, a support base and an upper opening through which the fragrance containers can be inserted into the case.

In this way, the bottles can be interchangeable once empty with others containing even different fragrances as they can be removed from the case, once empty, and be replaced with new ones.

In this way the entire assembly 1 described can be reused several times.

FIG. 1 therefore shows two bottles (3, 4), or containers, with a semi-circumferential shape so as to be able to fit inside the container with the flat sides, corresponding to the maximum diameter, facing towards each other. In this way, when coupled within the case they take on the overall circumferential or cylindrical shape of the container, thus adapting to the shape of the seat where inserted.

The case can however, in theory, have any shape, as also the bottles which are arranged interchangeably inside it, the case being able to contain, if of adequate shape, even more than two bottles.

The example of two bottles shown in FIG. 1 is therefore not limiting and it is obvious that what is described below can be adapted to any number of bottles.

The bottles 3 and 4, as in the known art, have dispensing tubes 5 and 6 which allows the perfume to be sprayed to the outside. By pressing on tubes 5 and 6, a dispensing system is activated which allows the liquid contained inside to rise through the tubes, exactly as in the known art.

The dispensing tubes are therefore inserted into the relative bottles and draw up the liquid contained inside, exactly as in the known art.

The bottles, in this case, are preferably disposable once the fragrance is finished and can also contain inside, in addition to the fragrance (liquid or gas), the expulsion gas, generally an inert gas.

The tube is translatable and any pressure on it causes a translation which activates the expulsion gas. As mentioned, this has been part of the known art for a very long time.

Still in accordance with the known art, dispensing can take place without necessarily any propulsion gas being present directly inside the bottle but instead by moving, still by pressing on the dispensing tube (for example the tubes 5 and 6 of FIG. 1). The tube moves and acts on a piston placed inside the container and which compresses the fragrance fluid contained (generally the liquid fragrance), thereby increasing the pressure which causes the liquid to rise and flow out along the tube itself.

These solutions, all being well known and used for a long time in many sectors (as also outlined in the paragraph on the known art), are not further detailed here.

According to the invention, a dispensing system is now integrated which allows the mixing of the two or more fragrances.

In light of this, therefore, FIG. 1 shows the pre-existing tubes 5 and 6 of the bottles which are connected to two respective tubes (5a, 6a) which converge at a mixing chamber 10.

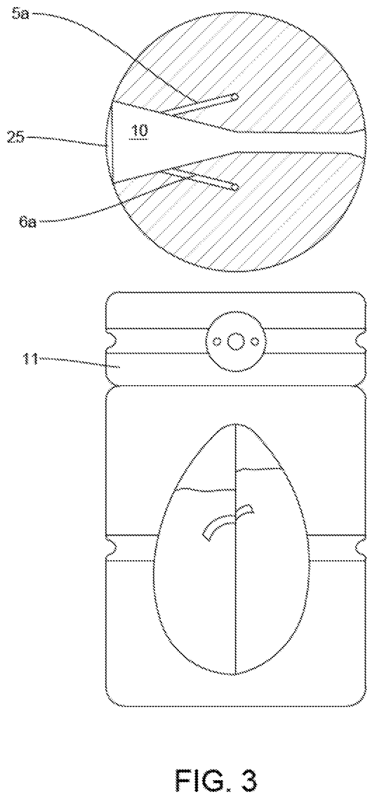

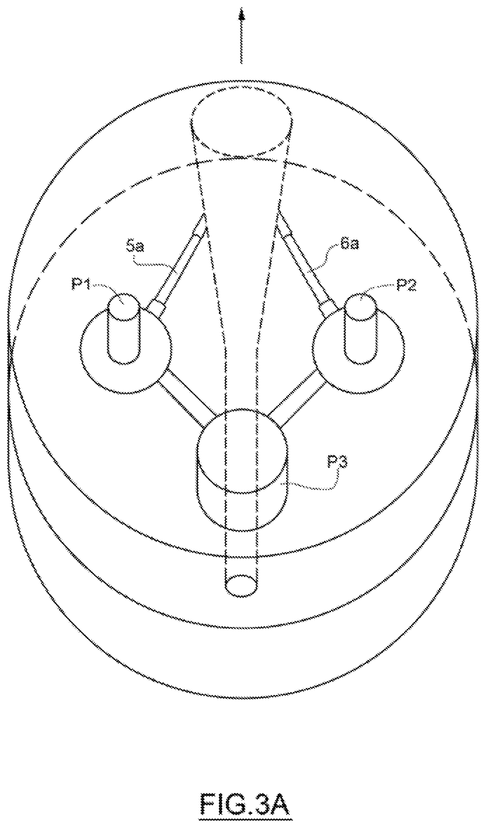

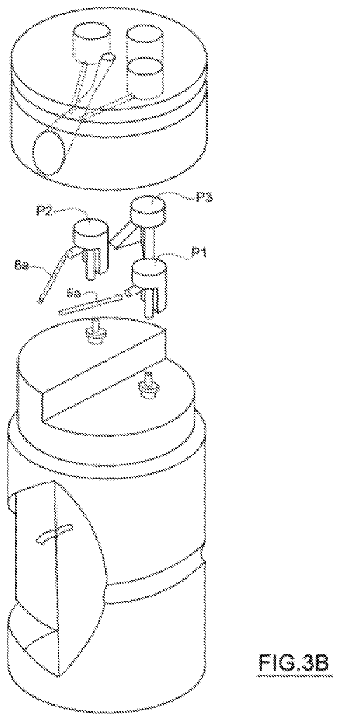

According to the invention, therefore, said mixing chamber 10 is now provided (see FIG. 3) to which the liquids coming from the two bottles converge and which therefore mix before being dispensed to the outside.

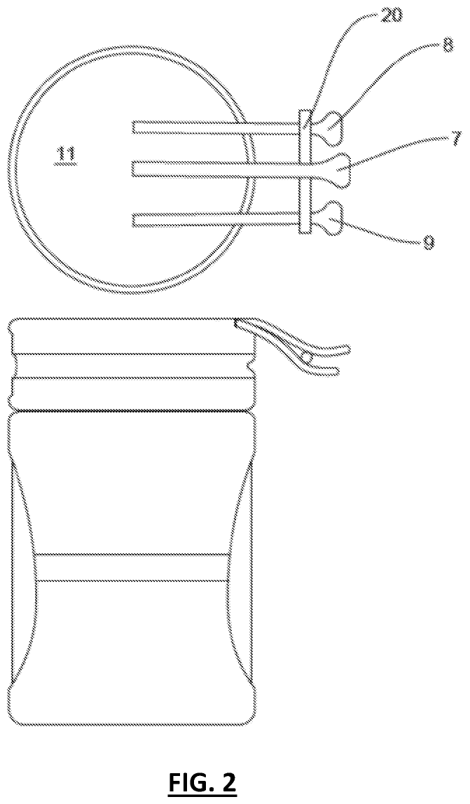

As shown in the section in FIG. 3, or as in FIG. 2, the case 2 can have a cap 11 in which said chamber 10 is made in one piece or as a separate component such that, when said cap is applied on the case, the system is ready for use.

Said mixing chamber 10 can therefore be obtained directly in the cap 11 (see section of FIG. 3) or it can be housed in a special seat obtained in the cap 11.

As shown better in FIG. 3, the two said tubes 6a and 5a, one of which is intended to be connected to dispensing tube 6 and the other is intended to be connected to dispensing tube 5, converge at the mixing chamber 10 (see FIG. 1).

The section of FIG. 3 therefore shows the housings in which are accommodated the tubes (5a, 6a) in the cap, before then being connected to the pre-existing ones 5 and 6 when the cap is applied.

Accordingly, therefore, the cap 11 may be arranged so that said tubes are obtained therein or are installed in special seats as can also be seen from the section of FIG. 3, so that, by applying the cap to the case, a fluid communication is automatically created between the tubes 5 and 6 of the bottles with those leading to the mixing chamber.

In particular, the application of the cap leads to coupling of the ends (5a′, 6a′) of the tubes (5a, 5b) with the ends (5′, 6′) of the tubes 5 and 6 of the fragrance containers, thereby creating said fluid communication between the containers and the mixing chamber and from there towards the outlet.

A lever system 7 can actuate the dispensing.

In particular, as shown in FIG. 2, the central lever 7 actuates the two levers 8 and 9 through the rigid rod 20 which connects the lever 7 to the levers 8 and 9.

Then by lowering the central lever 7, the levers 8 and 9 are lowered simultaneously and by the same quantity, and press on the tubes 5a and 6a and therefore on the tubes 5 and 6, crushing and actuating them for delivery as in a normal spray.

Tubes 5a and 6a are flexible.

The lever system is therefore movable similarly to buttons so that it is lowered in correspondence with the pressure acting on it.

Alternatively, the lever system can be hinged and with the connection point of the two lateral levers to the relative tubes (5a and 6a) which are interposed between the lever hinging axis and the external end of the lever 7 on which to act with pressure. In this way, by pressing on the end of the lever 7, the rotation of said lever 7 towards the bottom of the cap causes a crushing of the flexible tubes 5a and 6a. In a further alternative, the hinging can be such as to connect to the main tubes 5 and 6 so as to raise them towards the tubes 5a and 6a during rotation, thereby having the same reciprocal pressure effect as that which causes the perfume to flow out.

Going therefore to the section of the cap in FIG. 3, the cap is preferably hollowed out in one piece starting from an external surface so as to create the mixing chamber 10 or the seat for housing it and so as to obtain the seats in which the flexible tubes 5a and 6a will be accommodated.

For example, the mixing chamber with the tubes 5a and 6a can be inserted already assembled in the seat of the cap.

The cap includes the aforementioned system of levers which is applied to the cap so as to connect on the back of the tubes 5a and 6a, such that the movement action of the levers (rotation or translation) generates a bending on the tubes 5a and 6a which act upon the tubes 5 and 6 to which they are connected, causing the dispensing, or cause an approaching motion of the tubes 5 and 6 towards the tubes 5a and 6a.

In this way, the liquid rises from the respective two tubes 5 and 6 independently and then being conveyed through the tubes 5a and 6a into the mixing chamber 10 where the two fragrances are mixed before then being dispensed normally to the outside through the outlet section 25, for example configured to vaporize the fragrance.

The arrangement and conformation of the tubes 5a and 6a is such that, when the cap is applied, they overlap and connect to the ends 5′ and 6′ of the tubes 5 and 6.

The outlet section 25, as shown in FIG. 3, is obviously integrated in the cap and can comprise a standard outlet hole used for dispensers (which vaporizes, for example).

In this way, it is therefore possible to mix precisely two different fragrances and it is possible in a simple way to create one's own fragrances using different bottles that are used with a system which becomes like a normal and single bottle.

The containing case allows the empty perfume bottles to be exchanged, but nothing excludes an embodiment of the invention in which the case is replaced by an integral container which provides two or more separate and isolated perfume containing chambers and which can be filled with different scents at various times.

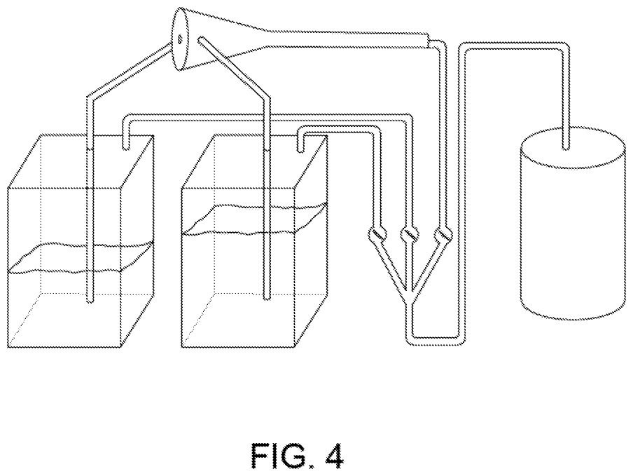

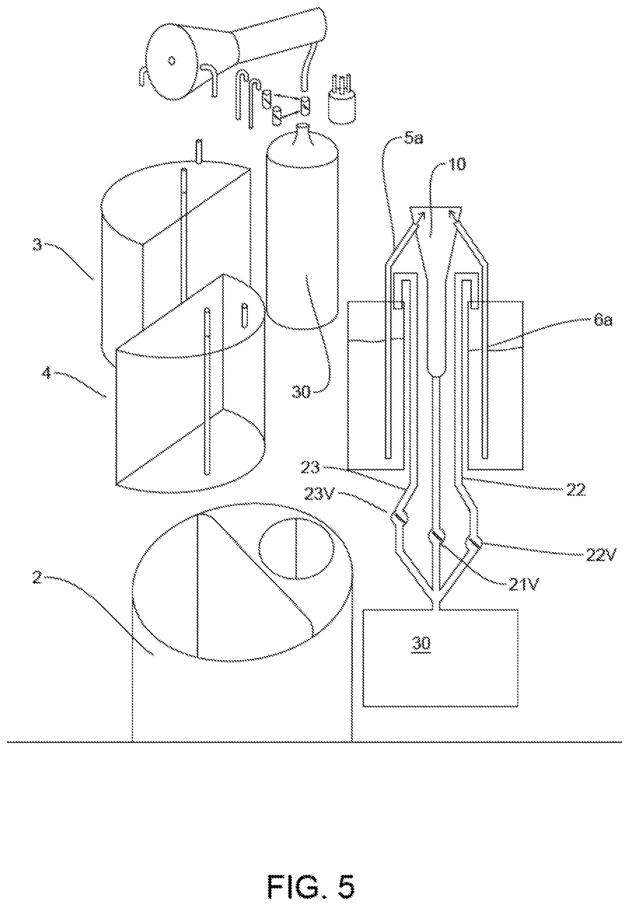

As shown in FIG. 3, and equivalently in the other configurations of the invention, the mixing chamber preferably has a Venturi-tube conformation which favors the expulsion and therefore the dispensing of the mixed perfume, in particular with the invention configuration described in the following FIGS. 4 and 5.

In a variant of the invention, shown in FIGS. 3A and 3B, the lever system is replaced by three pushbuttons (P1, P2, P3), one of which is connected to a flexible tube (5a), the other connected to the other tube (6a) and the third connected in a rigid connection to both tubes.

In this way, it is possible to choose whether to dispense a single perfume by acting on a single button connected to the single flexible tube (5a, 6a) or to dispense the mix by pressing the button that simultaneously activates and presses on both tubes (5a, 6a).

In use, therefore, the user applies the cap 11 and in this way, automatically, the application of the cap will bring the tubes (5a) and (6a) to connect with the tubes of the containers 5 and 6, in particular the ends (5a′) and (6a′) connect to the respective ends (5) and (6).

At this point, by acting on the lever 7, the two tubes (5a, 6a) are moved at the same time, and press on the tubes 5 and 6 causing a dispensing of the products which rise towards the mixing chamber 10 where they mix before flowing out.

FIG. 4 and FIG. 5 show a more complex variant of the present invention in which the case 2 is always present with the seat for containing two or more fragrance containers (the figure shows two but there could be more than two).

The cap which includes the mixing chamber and the outlet section is also present.

The tubes of the provided fragrance containers and a further container converge at the cap.

Therefore, as mentioned above, element 11 is present, that is the cap, which comprises inside the mixing chamber 10 introduced for the first configuration and, as said, preferably with a Venturi-tube conformation.

FIG. 5 shows the same tubes (5a, 6a) which converge at the mixing chamber 10, or which in this case connect the mixing chamber directly with the fluid contained in the relative bottle.

Unlike the previous solution, in this case the dispensing quantity is controlled through an external container 30 of compressed inert gas which dispenses the gas under pressure through suitable tubes (22, 23) inside the respective containers 3 and 4 so as to create a rising pressure on the liquid which rises from the bottle along the tubes 5a and 6a on the basis of said pressure.

These tubes are indicated in FIG. 5 with the numbering (22, 23).

Along these tubes 22 and 23, in a predetermined point downstream of the container 30, there are valves for regulating the fluid which are used to regulate the inward flow of inert gas. This therefore allows variation of the pressure acting on the surface of the liquids contained in the bottles and therefore allows the quantity of fragrance coming out of each bottle to be modified.

For example, giving a greater quantity of inert gas along the tube 22 with respect to the tube 23 means more liquid fragrance contained in the relative container 4 flows outward along the tube 6a than that coming from the tube 5a connected to the other container 3. In this way, the mixing that takes place will contain more quantities of a perfume in one bottle than in another.

The adjustment can be varied at will depending on the inward flow of inert gas that is applied in the two tubes 22 and 23 for which, for example, a 50% mix of fragrances may be produced (i.e. half of one type and half of the other) as well as mixes with any other percentage.

A central tube, again provided with a control valve in this case 21V, connects the container of inert gas 30 to the chamber 10 so as to create a thrust flow which facilitates the pulling of the mix towards the outlet section, further ensuring emptying of the chamber 10.

This thrust from the tailpiece of the chamber 10 is optimized thanks to the Venturi-shaped conformation.

The perfume contained in the bottles can theoretically be of any type, liquid and/or gas, and is therefore fluid and can be for both ambient air environments and for human/animal use.

Preferably, however, the fragrance is meant for human use.

As shown in FIG. 5, the valves 23V, 22V and 21V, responsible for the inward flow of inert gas are provided, and therefore, according to their opening/closing value, the fragrance mix and also the dispensing speed can easily be adjusted.

A mechanical, manual system can allow easy valve opening/closing adjustment even with intermediate opening and closing values (therefore not necessarily ON/OFF).

For example, the whole may be controlled with the three mechanical pushbuttons on the cap described above which, instead of acting on the flexible tubes, act on the valve opening/closing mechanism.

Whenever a valve opens, the gas contained in the container is released along the path relative to the opening of the valve.

Alternatively, an electro-mechanical system can be provided which automatically controls an opening of the valves which could be solenoid valves managed by an electronic selector.

In this way, with an electronic command, it is possible to control a precise opening by a predetermined quantity of the valves.

An electric motor can therefore control the opening/closing and therefore the position of the valves, including remotely or with control integrated in the dispenser.

In a simple way, therefore, with an electronic management, the desired adjustment may be made.

The central flow of inert gas that goes to the tailpiece of the mixing chamber 10 could also be timed (i.e. the valve, in addition to opening, is commanded with a predetermined and variable opening time) so as to guarantee emptying of the chamber, depending on requirements.

The user can therefore adjust the opening of the valves 22V and 23V to regulate the inward flow of inert gas into the two perfume containing chambers 3 and 4 and then adjust the delivery quantity accordingly.

The two perfumes enter the chamber 10 where they are mixed and are pushed towards the outlet section by the inward flow of inert gas which moves from the container 30 to the tailpiece of the chamber 10.

The Venturi-tube conformation promotes the expulsion and a timing of the gas flow 30 to the tailpiece of the Venturi tube can promote emptying of the chamber 10 if the gas is injected for a certain time (for example, a few seconds) after the flow of the two fragrances into said chamber 10 is interrupted.

This operating principle is therefore identical to the first configuration, except for the use of an external canister (i.e., a generic container) of inert gas which acts as a propeller and except for the possibility of being able to mix fragrances at different percentages thanks to use of the valves.

A further intermediate configuration, in terms of structural complexity, may be considered between the first and the second configurations described.

The main elements remain unchanged, that is the tubes (two or more than two) each of which connects, at one end to a respective fragrance container and, at the opposite end, to the mixing chamber.

Obviously, similarly to the first configuration, there is a closure cap which incorporates the mixing chamber 10 and the tubes for connection to the external propulsion gas cylinder and to the perfume dispensing tubes.

Again in this case, preferably, the mixing chamber has a Venturi-tube conformation since there may be a tube at the rear which, however, instead of connecting to a container 30 of inert gas, is instead connected to a flexible and deformable rubber ball with air inside which can be manually inflected (squeezed) to introduce air into the Venturi tube which results in suction of liquids from the containers into the Venturi tube. In essence, the suction and spray system is the system known and used for years in old-fashioned barbershops which had bottles of lotions sprayed by means of a spray system activated by pressing a deformable ball (the classic barbershop bulb-pump containers).

In all the configurations, sizing of the parts can be freely selected in order to optimize the effects.

The invention claimed is:

1.-22. (canceled)

23. A system for dispensing a fragrance, comprising:
a first container and a second container each adapted to contain a first fragrance and respectively a second fragrance, the first and second containers each comprising a main tube for expulsion of the first and respectively the second fragrance;
a dispensing device configured to expel the first and the second fragrances, the dispensing device providing a dispensing pathway that guides the first and the second fragrances towards an outlet section, the dispensing pathway comprising:
a mixing chamber configured to receive the first and the second fragrances coming from the first and respectively the second containers and causing the first and the second fragrances to be mixed therein before being expelled outside of the dispensing device; and
a first and a second auxiliary tube each connected at a first end to the mixing chamber so that the first and the second fragrances move along their respective main tubes to converge at the mixing chamber via the first and respectively the second auxiliary tubes;
a containing case forming a seat that receives the first and the second container; and
a cap configured to be applied on top of the containing case, the cap comprising the mixing chamber and the outlet section, the cap further defining at least one passage housing, at least partly, the first and the second auxiliary tubes,
wherein the first and the second auxiliary tubes each have a second, free end opposite to the first end, the second free ends being disconnected from the main tubes, the free ends being further configured to each separably connect to one of the main tubes when the cap engages the containing case, so as to generate an outlet path toward an outside and to separate the first and the second auxiliary tubes from the main tubes when the cap is separated from the containing case, the cap being further comprising a dispensing actuation system.

24. The system according to claim 23, wherein the dispensing actuation system comprises a lever system applied to the cap, the lever system causing a movement of the first and the second auxiliary tubes that generates a pressure on the main tubes to which the first and the second auxiliary tubes are connected.

25. The system according to claim 24, wherein the lever system comprises:
a central lever;
two lateral levers;
a transversal rigid rod connecting the central lever to the two lateral levers so that, by pressing on the central lever toward the cap, a simultaneous movement is caused of the two lateral levers, one of the two lateral levers being connected to the first auxiliary tube and another one being connected to the second auxiliary tube so that a movement of the two lateral levers toward the cap causes a movement of the first and the second auxiliary tubes which generates the pressure on the main tubes.

26. The system according to claim 25, wherein the dispensing actuation system comprises a pushbutton system applied to the cap, the pushbutton system causing a movement of the first and the second auxiliary tubes, which generates a pressure on the main tubes to which the first and the second tubes are connected.

27. The system according to claim 26, wherein the pushbutton system comprises a plurality of buttons, one of the buttons being connected to the first auxiliary tube and another button being connected to the second auxiliary tube so that pressing the pushbuttons toward the cap causes a movement of the first and the second auxiliary tubes, which generates the pressure on the main tubes to which to which the first and the second tubes are connected.

28. The system according claim 27, wherein the first and the second auxiliary tubes are made of a flexible material so as to deform in response to an actuation of the two lateral levers or of the buttons connected thereto, thereby causing the pressure on the main tubes.

29. The system according to claim 23, further comprising thrust means that move the first and the second fragrances towards the outlet section from the first and the second containers along the main tubes so as to draw up the first and the second fragrances.

30. The system according to claim 29, wherein the thrust means are integrated inside the first and the second containers.

31. The system according to claim 29, wherein the thrust means comprise a thrust fluid contained in the first and respectively the second container, the thrust fluid, when activated, causing the first and the second fragrances to flow out, due to a pressure acting on the respective main tube.

32. The system according to claim 29, wherein the thrust means comprise a piston slidably arranged inside each of the first and the second container, the piston being connected to a respective main tube so as to move towards a bottom of the respective container, generating an increase in internal pressure according to a thrust acting on the respective main tube.

33. The system according to claim 29, wherein the thrust means are separated from the first and the second container.

34. The system according to claim 29, wherein the thrust means comprise a third container of a pressurized fluid, the container being configured to inject the pressurized fluid into the first and the second containers through a first tube so as to cause the first and respectively the second fragrance to flow out, the containing case providing a seat for containing the third container of the pressurized fluid.

35. The system according to claim 34, further comprising a second tube which connects the third container with a tailpiece of the mixing chamber so that the pressurized fluid injected into the tailpiece of the mixing chamber generates a thrust which facilitates the expulsion of the mixed first and second fragrances outside of the dispensing device, the cap further forming a passage in which are housed the first and the second auxiliary tubes for at least a lengths thereof, the first and the second auxiliary tubes being connected to the mixing chamber and the second tube.

36. The dispensing device according to claim 34, wherein the first and the second tubes converge on the third container and are controlled in opening and closing by flow control valves.

37. The dispensing device according to claim 36, wherein the opening and the closing of the flow control valves is actuated with a control button disposed on the cap.

38. The dispensing device according to claim 36, wherein the flow control valves are configured to assume open, closed, and intermediate positions.

39. The system according to claim 23, wherein the containing case is cylindrical.

40. The system according to claim 23, wherein the seat of the containing case has an open top to enable a removable insertion of the first and the second containers.

41. The system according to claim 23, wherein the cap is removable from the containing case.

42. The system according to claim 23, wherein the mixing chamber has a Venturi-tube conformation.

43. A method of enabling a dispensing of a mix of fragrances comprising a plurality of distinct fragrances, the method comprising:
providing a system according to claim 23;
activating the system to cause the mixing chamber to receive the first and the second fragrances coming from the first and the second containers, thus causing the first and the second fragrances to be mixed in the mixing chamber before the expulsion of the mixed first and second fragrances to the outside.

44. A dispensing device for dispensing a fragrance coming from a first and a second container of a fragrance, the dispensing device including:
a dispensing pathway configured to guide fragrances contained in the first and the second containers toward an outlet section,
wherein the dispensing pathway comprises:
a mixing chamber configured to receive the first and the second fragrance coming from the first and respectively the second container, thus causing the first and the second fragrances to be mixed in the mixing chamber before being expelled to an outside environment of the dispensing device,
a first and a second auxiliary tube, the first and the second auxiliary tubes being connected at a first end to the mixing chamber;
a containing case defining a seat for the first and the second container; and
a cap configured to be applied on top of the containing case, the cap comprising the mixing chamber and the outlet section for the first and second fragrances, the cap further defining at least one passage in which the first and second auxiliary tubes are housed for at least part of a length thereof, the first and second auxiliary tubes being connected to the mixing chamber, the first and second tubes each having a second, free end opposite the first end, the second, free ends being configured to be connected, separably, to one of the first or the second fragrance containers when the cap is applied on the containing case after the first and the second containers are placed in the containing case, so as to generate an exit path for the first and the second fragrances from the first and respectively the second container towards the outside environment and to separate from the first and the second containers upon separation of the cap from the containing case, the cap being further provided with a dispensing actuation system.
